(19) United States
(12) Patent Application Publication
(10) Pub. No.: US 2008/0061154 A1
(43) Pub. Date: Mar. 13, 2008

(54) Transportation Ticket Reading Apparatus

(75) Inventor: Tony Arkinstall, Berkshire (GB)

Correspondence Address: WADDEY & PATTERSON, P.C., 1600 DIVISION STREET, SUITE 500, NASHVILLE, TN, 37203, US

(73) Assignee: ACCESS KEYBOARDS LIMITED, Berkshire (GB)

(21) Appl. No.: 11/852,570

(22) Filed: Sep. 10, 2007

(30) Foreign Application Priority Data
Sep. 8, 2006 (GB) 06177770.3

(51) Int. Cl. G06K 21/00

(52) U.S. Cl. 235/495

(57) ABSTRACT

A transportation ticket reading apparatus includes a housing into which a transportation ticket can be inserted and a module (24) including at least one read device (48) for reading data from a transportation ticket, such as a boarding pass or ATB, inserted into the housing. The module includes at least one formation (32) for engaging a mounting provided in the housing. The formation (32) and respective mounting are configured to enable the module to be push-fit mounted in a use position in the housing. The push-fit mounting of the module (24) facilitates servicing and repair, including removal of material causing jamming.

### CROSS-REFERENCES TO RELATED APPLICATIONS

This application is a Non-Provisional Utility application which claims the benefit of United Kingdom Patent Application No. 06177770.3, filed Sep. 8, 2006, which is hereby incorporated by reference in its entirety.

### BACKGROUND OF THE INVENTION

1. Field of the Invention

The invention relates to transportation ticket reading apparatus and particularly, but not exclusively to, transportation ticket reading apparatus for reading boarding passes and automated ticket/boarding passes (ATBs) at airports.

2. Background to the Invention

In order to be allowed through a boarding gate to board an aircraft, a passenger must have a boarding pass. Traditionally, passengers have obtained a boarding pass by handing a paper ticket to a member of the staff at an airline's check-in desk. Having made the necessary identity checks and allocated a seat to the passenger, the staff member would print out a boarding pass for the passenger to present at the boarding gate. Relatively recently, many airlines have installed self-service check-in kiosks. These allow a passenger who does not have baggage to check-in without the inconvenience of visiting a check-in desk. In response to the input of the requisite data, a check-in kiosk prints out a boarding pass in much the same way as at a traditional check-in desk. In either case, the boarding pass is usually an elongate piece of relatively stiff card, or similar such material, printed with both manually and machine readable information. The machine readable information has traditionally been carried in a magnetic stripe that runs along the length of the boarding pass, although any other suitable machine readable form, such as barcode can be used.

At a boarding gate, a boarding pass can be checked manually. However, many airlines provide ticket reading apparatus that can verify the validity of a boarding pass by reading data carried in the magnetic stripe.

### BRIEF SUMMARY OF THE INVENTION

The invention provides transportation ticket reading apparatus comprising a housing into which a transportation ticket can be inserted and a module comprising at least one read device for reading data from a said transportation ticket inserted in the housing and at least one formation for engaging a mounting provided in said housing whereby said module is push-fit mounted in a use position in said housing. The module may define an aperture through which a portion of a ticket transport device protrudes so that it can engage a ticket inserted into the apparatus and/or define a guide path for the ticket.

The invention also includes a module for a transportation ticket reading apparatus, the module comprising at least one read device for reading data from a transportation ticket and at least one formation for engaging a mounting in a said transportation ticket reading apparatus whereby the module is push-fit mountable in a use position in the transportation ticket reading apparatus. The module may define an aperture through which a portion of a ticket transport device protrudes so that it can engage a ticket inserted into the apparatus and/or define a guide path for the ticket

The invention also includes a flight ticket reading apparatus comprising:

a housing into which a flight ticket can be inserted for reading data therefrom;

a transport mechanism in said housing for transporting a said ticket to a read position, said transport mechanism comprising an endless belt cantilever supported within said housing; and

a module push-fittable into a use position in said housing, said module defining guiding for guiding a said ticket during transport to said read position and ticket reading equipment for reading data from a said ticket disposed at said read position.

The invention also includes a transportation ticket reading apparatus comprising a module comprising at least one data read device for reading data from a transportation ticket, said module being quick-release mounted in the apparatus. The module may define an aperture through which a portion of a ticket transport device protrudes so that it can engage a ticket inserted into the apparatus and/or define a guide path for the ticket.

The invention also includes a transportation ticket reading apparatus comprising a module that carries the or each data read device of the apparatus and/or the or each ticket detection sensor of the device, said module defining a transportation ticket guide path in the apparatus. The module may define an aperture through which a portion of a ticket transport device protrudes so that it can engage a ticket inserted into the apparatus.

The invention also includes a transportation ticket reading apparatus in which the or each read device for reading data from a ticket and the or each sensor for detecting the presence of a ticket at a location in the apparatus is carried on a common mounting device. The mounting device may define an aperture through which a portion of a ticket transport device protrudes so that it can engage a ticket inserted into the apparatus and/or define a guide path for the ticket.

The invention also includes a transportation ticket reading apparatus comprising a ticket transport device, said ticket transport device comprising an endless belt fitted on a drive and support mechanism that is mounted on a cantilever support whereby the endless belt can be removed from the ticket transport device by a movement away from the cantilever support. The movement is preferably generally parallel to an axis of rotation of a drive roller of the drive and support mechanism and/or the cantilever support preferably extends generally parallel to that axis.

In this application, a transportation ticket is a ticket for any form of transportation that has data to be read by machine and in particular, airline tickets, airline boarding passes and ATBs.

### BRIEF DESCRIPTION OF THE SEVERAL VIEWS OF THE DRAWINGS

In order that the invention may be well understood, an embodiment thereof, which is given by way of example only, will now be described with reference to the drawings in which:

FIG. 1 is a schematic perspective view of a transportation ticket reading apparatus;

FIG. 2 is a schematic perspective view of the transportation ticket reading apparatus of FIG. 1 in an opened condition;

FIG. 3 is a perspective view of a module of the transportation ticket reading apparatus of FIG. 1; and

FIG. 4 is a front end section view of the lid of the transportation ticket reading apparatus looking diagonally from right to left in FIG. 1.

### DETAILED DESCRIPTION OF THE INVENTION

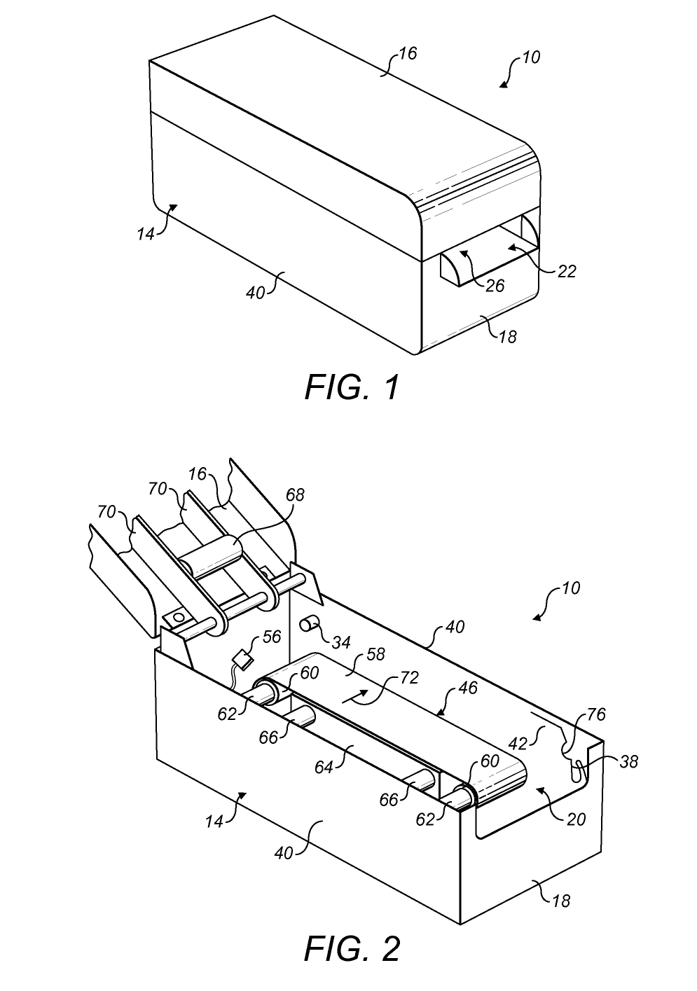

Referring to FIGS. 1 and 2, a transportation ticket reading apparatus 10 for reading data from aircraft boarding passes, including ATBs, comprises a housing consisting of a first, or base, portion 14 and a second portion, or lid 16. The lid 16 is pivot connected to the base portion 14 so that it can be moved from the closed, use, position shown in FIG. 1 to the open position shown in FIG. 2. The base portion 14 and lid 16 are preferably configured such that a portion, or portions, of the lid or components fitted to the lid can snap-fit onto the base portion or components fitted in the base portion so as to provide rapid entry to the interior of the housing and rapid securing of the lid to the base portion. However, snap-fitting of the lid is not essential and other forms of quick-release securing, for example clasps, could be used. It will also be appreciated that quick-release is not essential and the lid 16 could simply be secured to the base portion 14 by screws of the like.

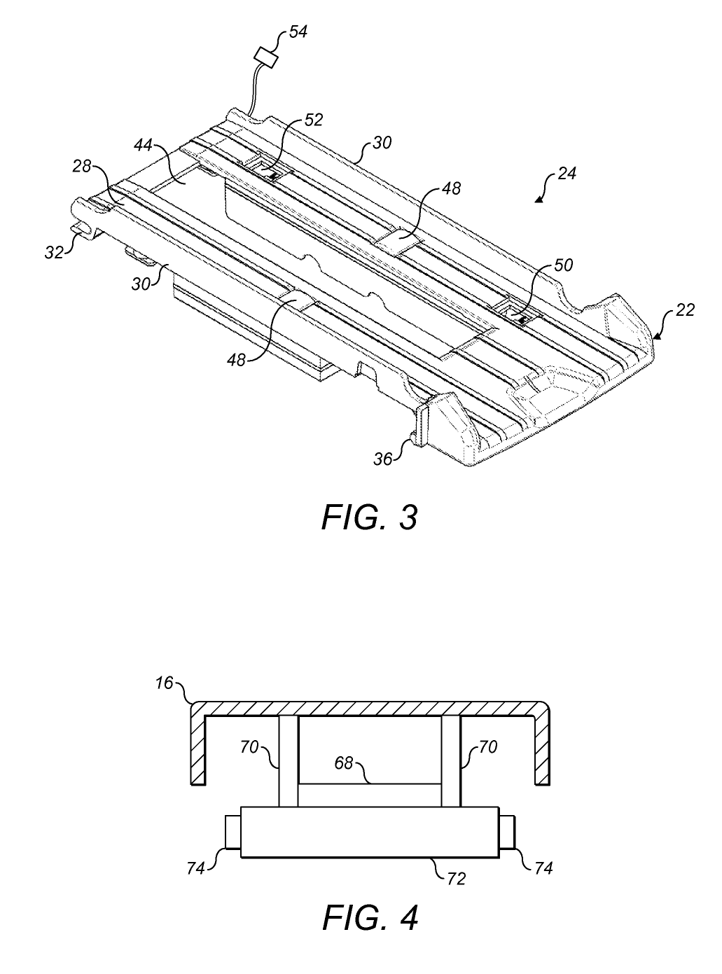

The front wall 18 of the base portion 14 has a notch 20 formed in its upper edge for receiving a front portion, or lip, 22 of a module 24 (best seen in FIG. 3) that is push-fit mounted in base portion 14 of the housing. The lip 22 and the lid 16 cooperate to define a ticket insertion aperture 26 through which a boarding pass can be inserted into the transportation ticketing apparatus 10.

Referring to FIG. 3, the module 24 is a molded plastics part comprising a base wall 28 that functions as a support surface for a boarding pass inserted into the transportation ticket reading apparatus 10 and integral sidewalls 30 that extend perpendicular to the base wall 28. The base wall 28 and sidewalls 30 define a guide path for boarding passes inserted into the transportation ticket reading apparatus 10.

The module 24 is push-fit mounted in the base portion 14 of the housing to permit quick and easy fitting and removal. The underside of the rear of the base wall 28 is provided with two lugs 32, only one of which can be seen in FIG. 3. The lugs 32 are located at opposite sides of the module 24 and are arranged to push-fit onto respective mounting pins 34 fixed to the base portion 14 of the housing. The lugs 32 are configured such that they snap-fit onto the mounting pins 34. When snap-fitted onto the mounting pins 34, the module 24 is able to pivot about an axis defined by the pins. The pivot axis extends perpendicular to the longitudinal axis of the housing and across its width parallel to the axis about which the lid 16 pivots.

Towards the front end of the module 24, a steel pin 36 is fixed to the underside of the base wall 28. The steel pin 36 extends across the width of the module 24 and projects beyond adjacent side portions of the module such that its ends can engage in respective recesses 38 that are fixed in the base portion 14 of the housing adjacent the sidewalls 40 of the base portion. The engagement of the steel pin 36 in the recesses 38 locates the front end of the module 24 in the housing. The recesses 38 are arranged such that once the lugs 32 have been snap-fitted onto the pins 34, the front end of the module 24 can be pushed down into the base portion 14 to bring the ends of the steel pin 36 into engagement with the recesses. This allows the module 24 to be quickly and easily fitted into and removed from the base portion 14.

The recesses 38 may be formed directly in the base portion 14 or in a separate member, or members, 42 that is/are fixed in the base portion. Whichever arrangement is used, the material may be a suitably resilient plastics material and the recesses 38 formed such that the ends of the steel pin 36 snap-fit into the recesses to provide rapid securing of the module 24 to the base portion 14 of the housing.

The base wall 28 of the module 24 is formed with an elongate rectangular aperture 44 that extends in the lengthways direction of the module. The aperture 44 is configured to receive the upper portion of a ticket transport device 46 (FIG. 3), which is described in more detail below.

Approximately midway along its length, the base wall 28 is formed with opposed recesses that house respective read devices 48 for reading data from the magnetic stripe of a boarding pass inserted into the transportation ticket reading apparatus 10. The read devices 48 are positioned in opposed spaced apart relation on opposite sides of the aperture 44 such that as long as a boarding pass is inserted into the aperture 26 with its magnetic stripe facing the base wall 28 of the module, it does not matter which end of the boarding pass is inserted first as the magnetic stripe will pass over one or the other of the read devices.

The base wall 28 of the module 22 is also provided with a recess 50 that houses a first sensor. The recess is positioned such that the first sensor can detect the insertion of a boarding pass into the transportation ticket reading apparatus 10. A second sensor is housed in a recess 52 formed towards the rear of the base wall 28. Signals from the first sensor are used to trigger start-up of the ticket transport device 46 to cause a boarding pass inserted into the insertion aperture 26 to be moved further into the transportation ticket apparatus 10 and a signal from the second sensor is used to determine that the boarding pass is fully inserted into the apparatus so that the ticket transport device 46 can be switched off while the data read from the magnetic stripe is processed.

The wiring from the read devices 48 and the sensors located in the recesses 50, 52 runs along the underside of the base wall 28 of the module 24 and is fed into a common plug 54. The plug 54 plugs into a socket 56 that is connected to a wiring loom in the base portion 14 of the housing. Thus, the electrical connection between the module 24 and the apparatus 10 can be rapidly made and disconnected by one simple operation.

The ticket transport device 46 comprises an endless belt 58 that can be made of any suitable polymer material. The endless belt 58 is fitted onto two rollers 60, one of which is driven by a suitable electric motor via gearing (neither of which are shown). The rollers 60 are cantilever mounted on respective pins 62 that are secured to a sidewall 40 of the base portion 14 of the housing or to a suitable chassis member fixed adjacent the sidewall. A center span support 64 for the endless belt 58 is positioned between the rollers 60 and is cantilever mounted on pins 66 in the same way as the rollers. The center span support 64 comprises a box like structure that provides support for a plurality of idler rollers (not show) that support the underside of the upper bout of the endless belt 58. As will be explained in more detail below, the cantilever support of the rollers 60 and center span support 64 permits rapid belt replacement.

The ticket transport device 46 further comprises idler rollers 68 (only one of which is shown in FIG. 2), which are supported by a pair of parallel spaced apart rails 70 that extend in the lengthways direction of the lid 16. The idler rollers 68 are arranged to bear against the surface of a boarding pass that faces away from the bottom wall 28 and serve to press the boarding pass onto the upper bout of the endless belt 58.

Referring to FIG. 4, the rails 70 have a steel bar 72 fixed to their front ends. The steel bar 72 has reduced diameter end portions 74. When the lid 16 is closed, the reduced diameter portions 74 locate in respective recesses 76 (one of which can be seen in FIG. 2) that are fixed in the base portion 14 of the housing. As with the recesses 38, the recesses 76 can be formed directly in the base portion 14 or in a separate member or members 42 that is/are fixed in the base portion. As with the recesses 38, the recesses may be formed in a resilient material allowing for snap-fitting of the reduced diameter portions 74 in the recesses 76 so as to provide quick-release securing of the lid 16 to the base portion 14.

In use, if the read devices 48 or the sensors housed in the recesses 50, 52 are damaged or worn, or material is jammed between elements of the ticket transport device 46 and the module 24, the problem can be quickly and easily rectified on site. First the lid 16 of the housing is pivoted to the open position shown in FIG. 2. Next the lip 22 of the module 24 is pulled, or pushed, upwardly (as viewed in FIGS. 1 and 2) causing the module to pivot on the mounting pins 34 and releasing the ends of the steel pin 36 from the recesses 38. If a jam is being cleared, this movement may be all that is required. If there is damage or wear to components of the module 24, or the jammed material is still not accessible, the module is simply pulled towards the front of the transportation ticket reading apparatus 10 to release it from the mounting pins 34. Then all that needs to be done in order to disconnect the module 24 from the apparatus 10 is to separate the plug 54 from the socket 56. Any jammed material is now easily cleared and the module 24 can then be put back into its use position by reversing the above described process. Similarly, if parts of the module 24 are worn or damaged, a new module can be fitted in place of the old module by reversing the above described process.

It will be appreciated that the module 24 can be removed from the transportation ticket reading apparatus 10 by three simple pulling operations to permit replacement or the removal of jammed material. Similarly, reinstatement is achieved by three simple push-fit operations.

If the endless belt 58 is worn or damaged, once the module 24 has been separated from the housing (electrical disconnection may not be necessary), the cantilever support of the rollers 60 and center span support 64 allows the belt to be slid off of the rollers by a simple transverse movement in the direction of the arrow 72 (see FIG. 2). A new belt can then be fitted by sliding it onto the rollers 60. It will be appreciated that quick and easy removal of the module 24 coupled with the cantilever support of the ticket transport device 46 allows for a quick and easy replacement of damaged and worn belts.

It will be understood that while in the embodiment it is preferred that the module 24 is removed from the transportation ticket reading apparatus 10 when changing the endless belt, this is not essential. Depending on the configuration of the apparatus, it may be sufficient to pivot the module away from the ticket transport device.

It will be appreciated that the components of the transportation ticketing read apparatus 10 that are most likely to be damaged or worn can be quickly and easily replaced and jammed material can be readily removed from the apparatus without a time consuming strip down of the apparatus and that this can be accomplished on site by unskilled operatives.

Although not shown, it will be appreciated that the transportation ticket reading apparatus 10 and/or the module 24 may be provided with means for securing the module in its mounted position additional to or as an alternative to snap-fitting of the lugs 32 and ends of the steel bar 36 with the mounting pins 34 and recesses 38. The securing means would preferably comprise a quick release device, for example a suitably arranged rotatable camming device could be used.

It will be appreciated that the lid 16 does not have to be pivot connected to the base portion 14 of the housing; it could simply lift off. It will also be appreciated that the benefit of quick removal and replacement of the module 24 may be obtained by providing the housing with a portion that can be moved to provide sufficient access to the module to allow it to be pulled from its mounted position and pushed back to its mounted position.

It will be appreciated that the steel bars 36 and 76 could be replaced by respective pairs of members for engaging in the recesses 38, 76. However, using a single steel bar in each case provides a more rigid structure with less likelihood of twisting of the respective part or of one side not properly locating in the respective recess.

No detailed description has been provided of the read devices 48 or of the sensors to be housed in the recesses 50, 52. In each case, any suitable read device/sensor may be used and since these are things that will be familiar to the skilled person, no further mention will be made of them here.

It will be understood that signals received from the read devices 48 and/or the sensors housed in the recesses 50, 52 may be processed within the transportation ticket reading apparatus 10 or transmitted by any suitable means for processing in another apparatus. These are matters that will be familiar to those skilled in the art and so will no further mention will be made of them.

The transportation ticket reading apparatus may be arranged to send valid tickets out through a designated exit aperture or back through the insertion aperture 26. Similarly, rejected tickets may be sent through a designated exit aperture or back through the insertion aperture. Again, these are matters that will be familiar to those skilled in the art and so no further mention will be made of them.

What is claimed is:

1. Transportation ticket reading apparatus comprising a housing into which a transportation ticket can be inserted and a module comprising at least one read device for reading data from a said transportation ticket inserted in the housing and at least one formation for engaging a mounting provided in said housing whereby said module is push-fit mountable in a use position in said housing.

2. Transportation ticket reading apparatus as claimed in claim 1, wherein the or at least one said formation and the mounting it engages are snap-fit engageable.

3. Transportation ticket reading apparatus as claimed in claim 1, comprising at least one securing member movable between a securing position in which it secures said module in said housing and a release position that permits removal of the module from the housing.

4. Transportation ticket reading apparatus as claimed in claim 1, wherein said module comprises a plurality of said read devices arranged such that data can be read from a said ticket inserted in the housing in a plurality of different permitted orientations of the ticket.

5. Transportation ticket reading apparatus as claimed in claim 1, wherein said module further comprises at least one sensor for sensing the presence of a said ticket at a read location in said housing.

6. Transportation ticket reading apparatus as claimed in claim 1, wherein said module comprises a structure defining guiding for a ticket inserted in the housing, the or each said read device being carried by said structure.

7. Transportation ticket reading apparatus as claimed in claim 6 wherein said module further comprises at least one sensor for sensing the presence of a said ticket at a read location in said housing and said at least one sensor is carried by said structure.

8. Transportation ticket reading apparatus as claimed in claim 6, wherein said structure is a single member.

9. Transportation ticket reading apparatus as claimed in claim 8, wherein said member is a plastics molding.

10. Transportation ticket reading apparatus as claimed in claim 1, wherein said housing comprises a first portion that is movable with respect to a second portion of the housing, the movement of said first portion permitting push-fit mounting of said module in said housing.

11. Transportation ticket reading apparatus as claimed in claim 10, wherein said first portion is pivot connected to said second portion whereby said first portion can pivot to a position that permits push-fitting mounting of said module in said housing.

12. Transportation ticket reading apparatus as claimed in claim 10, wherein said first portion is secured to said second portion by at least one quick release arrangement.

13. Transportation ticket reading apparatus as claimed in claim 1, wherein the or at least one said formation and the mounting it engages are arranged such that when engaged pivoting movement of the module with respect to the housing from said use position is permitted.

14. Transportation ticket reading apparatus as claimed in claim 1, further comprising a transport device for transporting a said ticket inserted into said housing, said transport device comprising an endless belt and movement of said module from said use position permitting removal of said endless belt from said transport device.

15. Transportation ticket reading apparatus as claimed in claim 14, wherein said transport device comprises at least two rotatable members for supporting said endless belt, said rotatable members being cantilever mounted to said housing.

16. Transportation ticket reading apparatus as claimed in claim 14, wherein said transport device further comprises a center span support device for supporting a central region of said endless belt, said center span support device being cantilever mounted to said housing.

17. Transportation ticket reading apparatus as claimed in claim 14, wherein a ticket engaging portion of said endless belt protrudes through an aperture provided in said module when said module is in said use position.

18. A module for a transportation ticket reading apparatus, the module comprising at least one read device for reading data from a transportation ticket and at least one formation for engaging a mounting in a said transportation ticket reading apparatus whereby the module is push-fit mountable in a use position in the transportation ticket reading apparatus.

19. An aircraft boarding pass reading device comprising a module as claimed in claim 18.

20. A flight ticket reading apparatus comprising:
a housing into which a flight ticket can be inserted for reading data therefrom;
a transport mechanism in said housing for transporting a said ticket to a read position, said transport mechanism comprising an endless belt cantilever supported within said housing; and
a module push-fittable into a use position in said housing, said module defining guiding for guiding a said ticket during transport to said read position and ticket reading equipment for reading data from a said ticket disposed at said read position.
